(19) United States
(12) Patent Application Publication
(10) Pub. No.: US 2010/0258590 A1
(43) Pub. Date: Oct. 14, 2010

(54) FOOD DISPENSER WITH PUMP FOR EASY LOADING OF CONTAINERS THEREIN

(75) Inventors: Thomas S. Orzech, New Milford, CT (US); Gary Helstern, Newtown, CT (US); Stephen C. Fog, New Canaan, CT (US); Richard L. Murphy, Montbrelloz (CH)

Correspondence Address: WINSTON & STRAWN LLP;PATENT DEPARTMENT, 1700 K STREET, N.W., WASHINGTON, DC, 20006, US

(73) Assignee: NESTEC S.A.

(21) Appl. No.: 12/820,888

(22) Filed: Jun. 22, 2010

Related U.S. Application Data
(62) Division of application No. 11/232,948, filed on Sep. 23, 2005.

(51) Int. Cl. B67D 7/58; B65D 37/00

(52) U.S. Cl. 222/136; 222/214; 222/135; 222/138; 222/207

(57) ABSTRACT

The present invention relates generally to dispensing system configured for dispensing a food product. The invention also relates to a peristaltic pump that has a pumping member configured to move along a path through a pumping position and a loading position. The pump also includes a motor in drivable association with the pumping member to move the pumping member along the path and a backing member having a surface configured to cooperate with the pumping member to pinch a conduit therebetween when the pumping member engages the conduit to establish peristaltic association in the pumping position to peristaltically pump a fluid therethrough. When the pumping member is in the loading position, the pumping member is disposed to allow the conduit to be received in and removed from a pumping space. The present invention also relates to a method for dispensing a food product using a peristaltic pump.

### CROSS-REFERENCE TO RELATED APPLICATIONS

This application is a division of application Ser. No. 11/232,948 filed Sep. 23, 2005, the entire content of which is expressly incorporated herein by reference thereto.

### FIELD OF THE INVENTION

The present invention relates generally to food dispensing systems. More particularly, the invention relates to food dispensing systems for pumping a fluid from a container.

### BACKGROUND OF THE INVENTION

Food dispensing systems have been regularly used in office, restaurant, and convenience store settings. Desirable characteristics of these systems include that the dispensing systems are easy to operate and maintain by the user and provide a hygienic and aesthetically pleasing interface for the user during operation. Some dispensers are adaptable to dispense a variety of food products.

Typical dispensing systems have been found to be lacking in one of these areas. In particular, U.S. Pat. No. 5,452,826 discloses a food dispenser that requires the user to clean parts of the dispenser each time a new food container is loaded within the dispenser. Specifically, after the food container is empty, food product remains in the portioning arrangement and the food product tube. Food product must be cleaned out of these parts in order to avoid contamination with the food product in the new food container, which can be different from the previous food product. Moreover, the dispensing mechanism requires that manual force be applied to the spring-biased lid each time food product is dispensed.

Additionally, European Patent EP0067466 discloses a food dispenser that is limited to dispensing a food product from a single container. The reference teaches a metering device used to dispense food portions from a food container.

It is also generally known that peristaltic pumps are relatively difficult and awkward for a user to manipulate when inserting and withdrawing tubing. Typically, a peristaltic pump must be disassembled or otherwise opened up to slide a roller away from a stator for releasing a used tubing therefrom or threading a new tubing therein. Specifically, U.S. Pat. No. 4,500,269 discloses many common deficiencies associated with the placement of tubing within a peristaltic pump.

Thus, there is a need for a dispensing system that can be easily loaded and unloaded with one or more food containers in a reliable and efficient manner that is preferably easy to keep in a hygienic condition.

### SUMMARY OF THE INVENTION

The present invention relates to a dispensing system that can include first and second container members containing first and second fluids, respectively. In a preferred embodiment that includes two containers, attached to the first and second container members are first and second conduits in respective fluid communication therewith to allow the fluids to pass through the conduits. At least one valve is disposed in the first conduit. This valve is configured to seal against leakage of the first fluid from the first conduit. A first pumping space is defined and configured for receiving the first conduit therein. This preferred embodiment also includes at least one pumping mechanism that has a first pumping member.

The first pumping member of the pumping mechanism is placeable in a loading position and a pumping position. Preferably, the pumping position includes a range of positions in which the first pumping member engages the first conduit. When the first pumping member is in the loading position, the first pumping member is disposed to allow the first conduit to be received in, and removed from, the first pumping space. On the other hand, when the first pumping member is in the pumping position, the first pumping member engages the first conduit in the first pumping space to establish fluid association to pump the first fluid therethrough.

Preferably, the valve is configured to allow the first fluid to flow substantially only outwardly and downstream of the first container member. Additionally, the first conduit preferably comprises a first compressible portion, the valve is preferably disposed downstream thereof portion, and the first pumping member engages the first compressible portion to pump the first fluid therethrough.

Preferably, the first pumping member of the dispensing system moves along a path that extends through the loading and pumping positions. More preferably, the first pumping member is configured to move along and against the first conduit to pump the first fluid therethrough when in the pumping position. The first pumping member can also be preferably configured to substantially pinch the first conduit during movement along the path in the pumping position. The pumping mechanism is preferably rotatable to rotate the first pumping member through the loading and pumping positions. In one embodiment, the pumping mechanism is preferably a peristaltic pump and the first pumping member is configured to substantially pinch the first conduit against the surface of a backing member and push the first fluid therethrough. In another embodiment, the pumping mechanism preferably includes a linear actuator that is operably associated with the first pumping member and configured to move the first pumping member between the loading position and the pumping position.

The configuration of the dispensing system is preferably adapted for easy loading of the conduits when the first pumping member is in the loading position. For this purpose, the first pumping member is preferably disposed to maintain a sufficient clearance with the first conduit in the loading position to allow the first conduit to be generally unimpeded during reception in and removal from the first pumping space. Preferably, the dispensing system also includes a controller that is configured for stopping the first pumping member in the loading position.

In the preferred embodiment, the dispensing system is a beverage dispenser, and the first and second fluids are beverage components. The beverage dispenser is configured for mixing the beverage components to prepare and dispense a beverage.

Additionally, the dispensing system preferably includes a compressible portion of the second conduit that is configured for engagement by a second pumping member. Preferably, at least one valve is disposed in the second conduit downstream of the second compressible portion, and the valve is configured to seal against leakage of the second fluid from the second conduit. The dispensing system further includes a second pumping space defined and configured for receiving the second conduit therein, and the pumping mechanism preferably includes a second pumping member disposed adjacent the second conduit when the second conduit is disposed in the second pumping space. Similar to the first pumping member, the second pumping member can be preferably positioned in a pumping and loading position.

Preferably, the first and second container members are disposed at a predetermined spacing from each other to allow simultaneous loading of the first and second conduits in the first and second pumping spaces when the first and second pumping members are in the loading positions. The dispensing system can further include a conduit guide configured for guiding the first and second conduits for loading in the first and second pumping spaces. The conduit guide preferably defines an upstream opening configured to facilitate reception therein of the first and second conduits which is larger than at least a portion of the conduit guide disposed downstream of the upstream opening.

Another preferred embodiment of the invention relates to a peristaltic pump that includes a pumping member that is configured to move along a path through loading and pumping positions. The peristaltic pump also includes a motor in drivable association with the pumping member to move the pumping member along the path and a backing member having a surface configured to cooperate with the pumping member to pinch a conduit therebetween when the pumping member engages the conduit to establish peristaltic association in the pumping position to peristaltically pump a fluid therethrough. When the pumping member is in a loading position, the pumping member is disposed to allow the conduit to be received in and removed from a pumping space.

Preferably, the pump is configured to fully release the conduit by moving the pumping member to the loading position. Also, the motor is preferably associated with the pumping member to rotate the pumping member along the path through the pumping and loading positions.

In one embodiment, the pump is part of a dispensing system that preferably includes a controller configured for controlling the motor to stop the pumping member in the loading position. In another embodiment, the dispensing system preferably includes first and second pumping members configured to move along first and second paths through loading and pumping positions. The motor is in drivable association with the first and second pumping members to move the pumping members along the first and second path, and first and second surfaces are preferably configured to cooperate, respectively, with the first and second pumping members to pinch, respectively, first and second conduits therebetween when the first and second pumping members engage, respectively, the first and second conduits to peristaltically pump first and second fluids therethrough. When the first and second pumping members are in a loading position, the first and second pumping members are preferably disposed to allow the first and second conduits to be received in and removed from first and second pumping spaces. Preferably, the peristaltic pump is configured for simultaneously stopping the first and second pumping members in the loading position.

The invention also relates to a method of operating a peristaltic pump, which includes moving a pumping member of the peristaltic pump in pumpable association with a conduit to peristaltically pump a fluid therethrough when the conduit is in a pumping space, and stopping the pumping member in a loading position such that the pumping member is disposed to allow the conduit to be received in and removed from the pumping space. During a single pumping cycle of the peristaltic pump, the pumping member sequentially moves along a path and repeatedly passes through loading and pumping positions along the path.

The present invention thus enables a user to easily load and unload a dispensing system in a hygienic manner and readily pump one or more fluids from fluid containers, such as to dispense a beverage.

### BRIEF DESCRIPTION OF THE DRAWINGS

FIG. 1 is a front cut-away view of one embodiment of the multiple-fluid sourcing assembly;

FIG. 2 is a side cut-away view of a first container/conduit assembly thereof;

FIG. 3 is a front cross-sectional view of a first conduit thereof;

FIG. 4 is a front cross-sectional view of an embodiment of a pumping assembly, with the pumping member in a loading position;

FIG. 5 is a front cross-sectional view thereof, with the pumping member in a pumping position;

FIG. 6 is a schematic view of an embodiment of a food dispenser;

FIG. 7 is a front perspective view of an embodiment of a fluid mixing collector;

FIG. 8 is a front perspective view of another embodiment of a pumping assembly;

FIG. 9 is a side cross-sectional view thereof, with the pumping member in a loading position;

FIG. 10 is a side cross-sectional view of the pumping assembly of FIG. 8, with the pumping member in a pumping position;

FIG. 11 is a front cross-sectional view of an embodiment of a pumping assembly in the loading position, using a linear actuator;

FIG. 12 is a front cross-sectional view of the pumping assembly thereof with a pinch member in the pumping position; and

FIG. 13 is a front cross-sectional view of thereof with a pumping member in the pumping position.

### DETAILED DESCRIPTION OF THE PREFERRED EMBODIMENTS

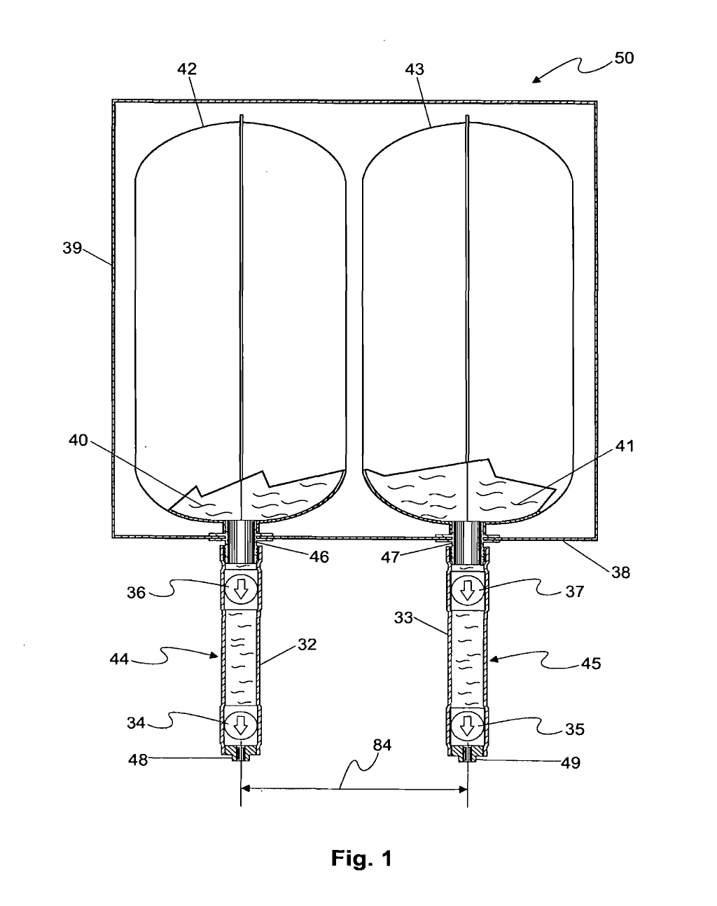

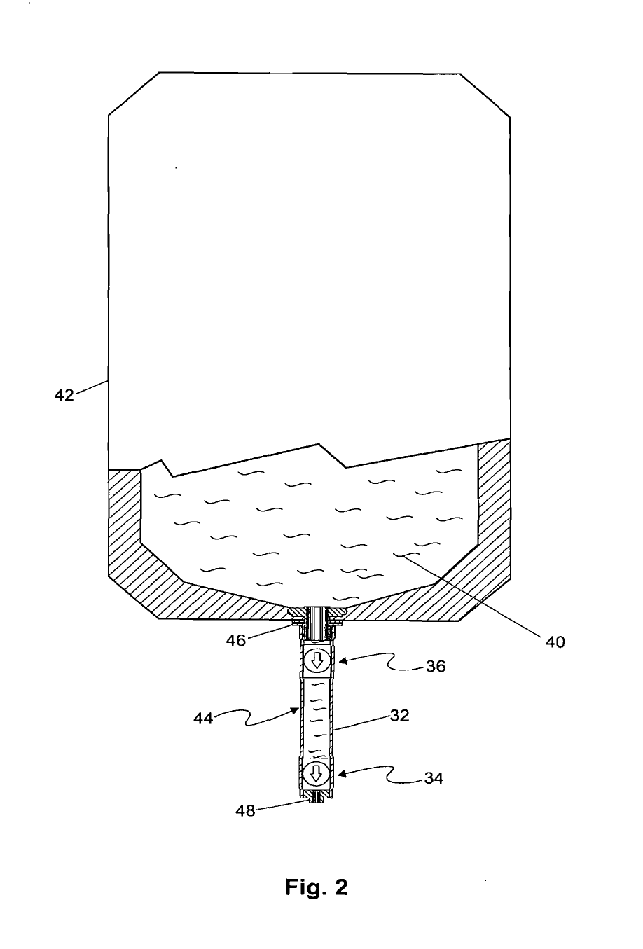

Referring to FIGS. 1 and 2, one preferred embodiment of the present invention includes a multiple-fluid sourcing assembly 50 that includes first and second Container members 42,43. Preferably, the container members 42,43 are of bag-in-box construction, although other configurations can be used. The first and second container members 42,43 contain, respectively, first and second fluids 40,41 for dispensing. In one embodiment of the assembly, the fluids preferably include food products, and more preferably beverage components that can be mixed with each other, or with another fluid to produce a beverage. Alternatively, ready-to-dispense food products may be used.

The preferred beverage is any beverage, hot or cold, that can be prepared from at least one concentrate, such as a syrup, a coffee concentrate, a cocoa concentrate, a milk concentrate, a tea concentrate, a juice concentrate, or a combination thereof. The concentrate is preferably mixed with a liquid, such as water, to produce the beverage suitable for consumption, such as a soft drink, a coffee drink, a tea drink, a juice, or a milk-based drink. Preferably, the beverages or beverage components include fluid concentrates. More preferably, the fluid concentrates include coffee or chocolate. In one embodiment, a coffee fluid-concentrate is used, which can include, for example, coffee solids, coffee aroma, and/or a whitener or dairy product.

Preferably, first and second conduits 44,45 are associated with the first and second container members 42,43 so that the respective conduits 44,45 are in fluid communication with the first and second container members 42,43. Preferably, the conduits 44,45 are made of flexible tubing and have first and second nozzles 48,49 at the ends thereof. Additionally, first and second fluid outlet members 46,47 are preferably disposed, respectively, at the bottom of the first and second container members 42,43 and are in fluid communication therewith and with the first and second conduits 44,45.

The sourcing assembly 50 also includes a mounting member 38 to which the first and second container members 42,43 are mounted. The mounting member 38 preferably includes a housing 39, as shown in FIG. 1, that is configured to house the first and second container members 42,43 therein. Preferably, the container members 42,43 are mounted such that the respective conduits 44,45 are disposed at a predetermined spacing 84 from each other. The predetermined spacing 84 is preferably dependent on the volume that the first and second container members 42,43 occupy. Preferably, the predetermined spacing 84 is at least about 30 mm and is at most about 100 mm. More preferably, the predetermined spacing 84 is about 50 mm to about 70 mm. The conduits 44,45 are preferably positioned substantially parallel to each other to leave the spacing of predetermined value 84 therebetween. In this manner, the predetermined spacing 84 between the conduits 44,45 can be sufficiently matched to a predetermined spacing of a conduit guide to facilitate alignment as the sourcing assembly 50 is loaded onto a pumping assembly. Alternatively, the conduits 44,45 can be disposed non-parallel with respect to each other.

The mounting member 38 also includes a rigid member, which can be of unitary construction with the housing 39 or a separate piece associated with the housing 39. The rigid member is preferably configured to connect the first and second fluid outlet members 46,47, which advantageously provides additional support to maintain the conduits 44,45 at the predetermined spacing 84 from each other. Preferably, the rigid member can be made of a rigid or semi-rigid material, and more preferably, the rigid member is a plate. Preferably, the material of the mounting member 38 includes a cardboard or plastic material, and the housing and rigid member can be of unitary construction.

A preferred embodiment of the first container member 42 and the associated fluid outlet member 46 and conduit 44 is shown in FIG. 2. The second container member 43, and the associated fluid outlet member 47 and conduit 45 are preferably of a similar configuration. The conduit 44 can be shorter than conduits generally used for food dispensers that include peristaltic pumps, since these typically require a sufficient length of tubing to wrap around the inside of a peristaltic-pump stator. The present arrangement can thus significantly reduce the amount of tubing that is required to dispense fluid, in some cases by over 45 inches as compared to typical peristaltic systems.

Preferably, the container member 42, fluid outlet member 46, and conduit 44 are configured as a closed system that preferably is prepackaged as a single manipulatable structure, as shown in FIG. 2. More preferably, the sourcing assembly 50 comes prepackaged and includes the first and second container members 42,43 mounted to the mounting member 38 and contained in the housing 39. This advantageously prevents or reduces the risk of contamination of the fluids 40,41 in the container members 42,43 and contamination of the internal workings of the dispenser. Moreover, the container member 42 and associated conduit 44, or the sourcing assembly 50, can preferably be entirely disposable upon completion of dispensing, which avoids having to flush fluid remnants from the internal tubing of the dispenser as is typically required in previous food dispensers.

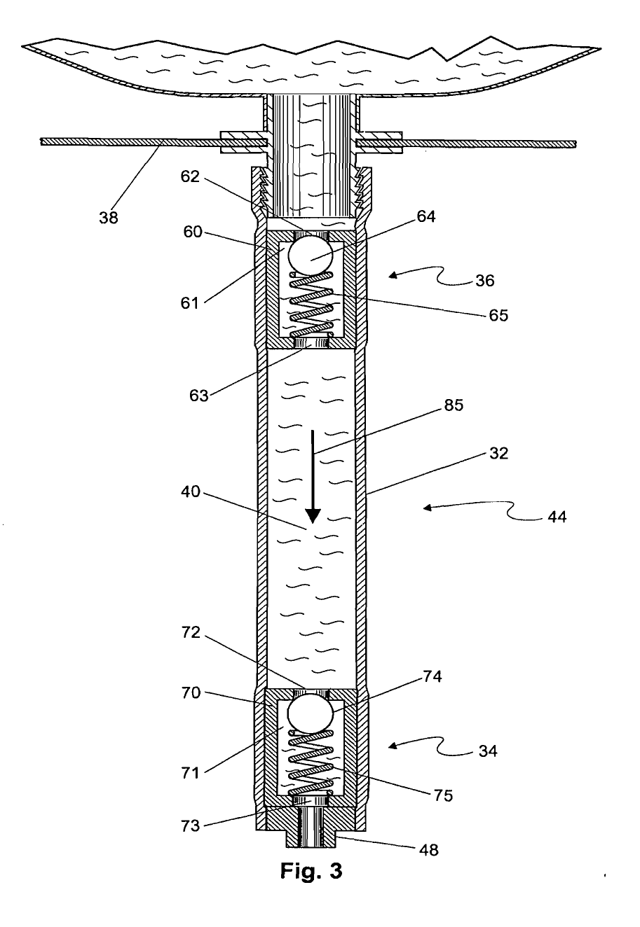

In a preferred embodiment that includes two container members, the first and second conduits 44,45 have, respectively, first and second upstream valves 36,37 and first and second downstream valves 34,35, as shown in FIGS. 1 and 3. The first and second conduits 44,45 are each preferably at least about 50 mm and more preferably at least about 80 mm in length, and are each preferably at most about 250 mm and more preferably at most about 200 mm in length. Disposed between the two valves, respectively, are first and second compressible portions 32,33 that are configured for association with a pumping member of a pumping mechanism. Preferably, the compressible portions 32,33 are made of a resilient flexible tubing and have axial lengths of at least about 1 inch and at most about 5 inches. More preferably the axial lengths of the compressible portions 32,33 is about 1.5 inches to about 3 inches. Preferably, the compressible portions 32,33 have an outside diameter of about 5 to 20 mm. More preferably, the compressible portions 32,33 have an outside diameter of about 10 to 15 mm. In one embodiment, the outside diameter is about 13 mm. The first and second nozzles 48,49 are respectively disposed downstream of the downstream valves 34,35.

The upstream valves 36,37 and downstream valves 34,35 are preferably disposed within their respective compressible portion 32,33 and configured to permit and impede the flow of fluid therethrough. The valves are also configured to seal against leakage of the first and second fluids 40,41 from the first and second conduits 44,45. Preferably, the first and second upstream valves 36,37 and the first and second downstream valves 34,35 are uni-directional valves that allow uni-directional flow of fluids 40,41 substantially only in a downstream direction 85 out of the container members 42,43. In the preferred embodiment, the valves 34,35,36,37 are check valves, such as spring-loaded, ball, check valves, as shown in FIG. 3. The valves 34,35,36,37 are configured to advantageously provide an accurate dosing of fluid upon compression of the compressible portions 32,33. Referring to the first conduit 44, for example, the first upstream and downstream check valves 36,34 each include annular members 60,70 that each define inner cavities 61,71 of each valve 36,34. Upstream openings 62,72 and downstream openings 63,73 of each valve 36,34 allow the first fluid 40 to pass through the cavities 61,71 of each valve 36,34.

Also preferably disposed within each cavity 61,71 are ball members 64,74 adjacent the respective upstream openings 62,72. The ball members 64,74 are each biased by resilient members 65,75 towards a closed position to block the respective upstream openings 62,72 and impede the flow of the first fluid 40 therethrough. Preferably, the resilient members 65,75 bias the respective ball members 64,74 toward the closed position with a sufficient closing force such that the ball members 64,74 impede the flow and prevent leaking of at least the entire column of first fluid 40 in the first conduit 44. More preferably, the resilient members 65,75 provide a closing force sufficient to impede the flow and prevent leaking of at least the volume of the first fluid 40 contained in half of the first container member 42, and even more preferably, of at least the volume of the first fluid 40 contained in the entire first container member 42.

As the compressible portion 32 is compressed, the pressure therein is increased to greater than atmospheric pressure. This positive pressure exerts a force on the downstream ball member 74 of the downstream valve 34, which causes the associated resilient member 75 to compress. As the resilient member 75 compresses, the ball member 74 moves in the downstream direction 85 and allows the first fluid 40 to enter the cavity 71 through the upstream opening 72 and exit through the downstream opening 73, and eventually exit the first conduit 44 through the nozzle 48. The increased pressure in the compressible portion 32 also exerts a positive force on the upstream ball member 64 of the upstream valve 36, which, along with the resilient member 65, causes the upstream ball member 64 to bias towards the closed position to block the upstream opening 62 and impede the flow of the first fluid 40 therethrough.

Upon decompression of the compressible portion 32, the pressure therein is reduced below atmospheric pressure, and this negative pressure and the resilient member 75 of the downstream valve 34 is able to bias the ball member 74 back against the upstream opening 72 to impede the flow of the first fluid 40 therethrough. With respect to the upstream valve 36, decompression of the compressible portion 32 creates a negative pressure which acts on the upstream ball member 64 and causes the associated resilient member 65 to compress. As the resilient member 65 compresses, the ball member 64 moves in the downstream direction 85 and allows the first fluid 40 from the first container member 42 to enter the cavity 61 through the upstream opening 62 and exit through the downstream opening 63 into the compressible portion 32. Advantageously, the act of compressing and decompressing the resilient compressible portion 32, together with the opening and closing of the upstream and downstream valves 36,34, allow the first fluid 40 to flow in substantially only the downstream direction 85 through the first conduit 44. While the compression and decompression of only the first compressible portion 32 has been described herein, the second compressible portion 33, and its associated upstream and downstream valves 37,35, are configured to act in the same manner.

Preferably, the spring-loaded, ball, check valves are about 40 to 60 mm in length, with an outside diameter of about 5 to 20 mm, and can cause local stretching of the conduit where placed. More preferably, the length of the check valves is about 45 to 55 mm, with an outside diameter of about 10 to 15 mm. Even more preferably, the length of the check valves is about 52 mm, with an outside diameter of about 13 mm. In other embodiments, the valves are molded of a thermoplastic material, and can be other types of valves, for example flapper valves. The valves can also be molded in the conduits as one piece.

Alternatively, the first and second conduits can preferably include, respectively, only first and second compressible portions therein and first and second downstream valves disposed downstream thereof, with no upstream valves disposed between the compressible portions and the containers. Thus, when the first and second compressible portions are resiliently compressed, the first and second fluids therein are forced, respectively, downstream through the first and second downstream valves, and when the first and second compressible portions are decompressed, the first and second fluids, respectively, are drawn into the first and second compressible portions.

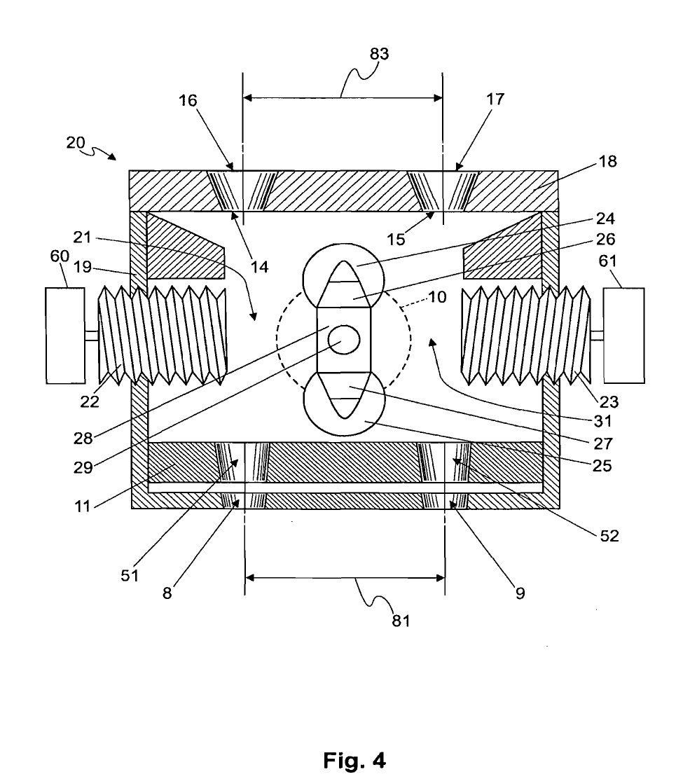

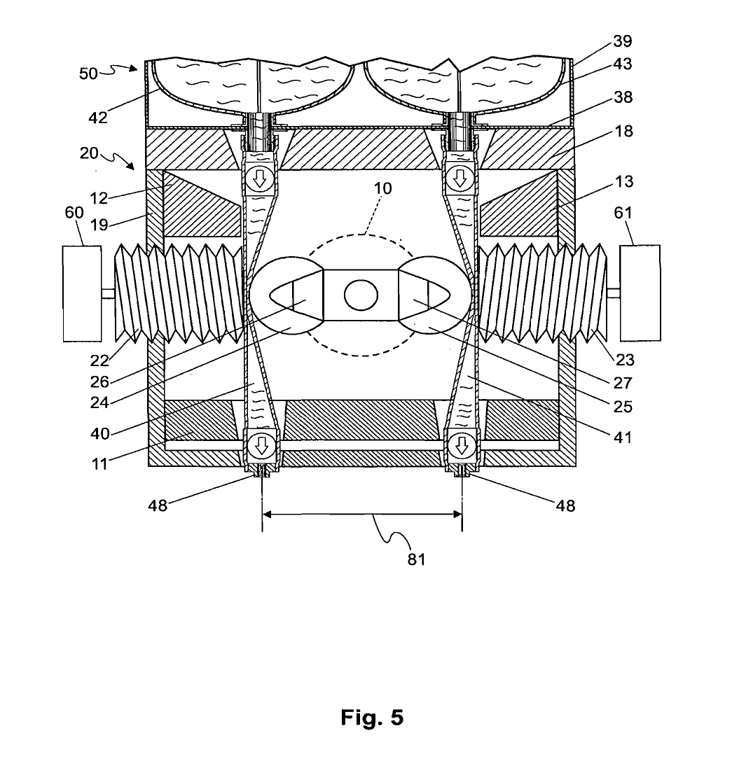

To facilitate downstream flow of fluids 40,41 out of the container members 42,43 and through the conduits 44,45, the sourcing assembly 50 can be brought toward a pumping assembly 20 such that the conduits 44,45 of the sourcing assembly 50 are disposed in respective first and second pumping spaces 21,31 as shown in FIGS. 4 and 5. The pump assembly 20 includes as pump housing 19. Preferably, the pump housing 19 is made of any suitable material such as a metal or plastic. The pump housing 19 is configured to allow for a stable and easy connection between the sourcing assembly 50 and the pumping assembly 20. In a preferred embodiment that includes two container members, the pump housing 19 preferably includes a conduit guide, which includes an upper conduit guide 18 that is configured for guiding the conduits 44,45 for placement of the compressible portions 32,33 in pumpable association with a pumping member 28 of a pumping mechanism in the respective pumping spaces 21,31.

The upper conduit guide 18 is configured for closely and stablely supporting the mounting member 38. Preferably, the upper conduit guide 18 includes guide openings to receive conduits 44,45 therein. More preferably, the guide openings include first and second upstream openings 16,17 configured to facilitate reception therein of the first and second conduits 44,45. The upstream openings 16,17 are preferably wider than the diameter of the conduits 44,45 to guide the conduits through the guide openings so that loading of the sourcing assembly is simple and easy. Preferably, the upstream openings 16,17 have a diameter of about 10 to 30 mm. More preferably, the diameter is about 15 to 25 mm. Even more preferably, the diameter is about 20 mm. The guide openings also preferably include first and second downstream openings 14,15, which are preferably narrower than the upstream openings 16,17, but slightly wider than the diameter of the conduits 44,45 to allow the receipt of the conduits therethrough. Preferably, the downstream openings 14,15 have a diameter of about 10 to 20 mm. More preferably, the diameter is about 12 to 16 mm. Even more preferably, the diameter is about 14 mm. The guide openings are preferably disposed from each other at a predetermined spacing 83, which matches the predetermined spacing 84, such that the conduits 44,45 are aligned in pumpable association with the pumping member 28 of the pumping mechanism. Preferably, the guide openings are conical or have another shape configured to guide the conduits 44,45 to fall directly in pumpable association with the pumping member 28 of the pumping mechanism.

Advantageously, the upper conduit guide 18 allows for the easy and intuitive loading and unloading of the sourcing assembly 50 from the pumping assembly 20. During loading of the sourcing assembly 50, the user can “drop and load” the conduits 44,45 into the pumping spaces 21,31 by loosely aligning the conduits 44,45 with the relatively wider upstream openings 16,17 of the upper conduit guide 18 and lowering or dropping the sourcing assembly 50 onto the pump assembly 20 to maintain a stable connection between the mounting member 38 and the upper conduit guide 18.

In one preferred embodiment, the conduit guide also includes intermediate guide members 12,13 that are disposed respectively on the right and left walls of the housing 19 above the compression members 22,23. Preferably, the intermediate guide members 12,13 are configured for preventing lateral movement of the conduits 44,45 upon insertion into the pumping spaces 21,31, thus maintaining the conduits 44,45 in a substantially parallel alignment with each other at the predetermined spacing 83. The conduit guide also includes a lower guide member 11, disposed below the compression members 22,23, with openings 51,52 for maintaining the conduits 44,45 in a substantially parallel alignment with each other at a predetermined spacing 81, which preferably matches the predetermined spacings 83,84. The pump housing 19 preferably includes first and second exit openings 8,9 configured to allow fluids 40,41 to exit the pumping assembly 20 through the nozzles 48,49.

In a preferred embodiment that includes two container members, the mounting member 38 is associated with the upper conduit guide 18 such that the first and second compressible portions 32,33 of the conduits 44,45 are compressible by the pumping member 28 of a pumping mechanism. In one preferred embodiment, the pumping mechanism includes a single pumping member 28 for engaging the conduits 44,45 to pump the fluids 40,41 therethrough. In other preferred embodiments, the pumping mechanism includes more than one pumping member or multiple pumping mechanisms, wherein each pumping mechanism includes separate pumping members to engage and pump the conduits. The pumping member 28 is preferably rotatably mounted within the pump housing 19 over a pump shaft 29 such that when rotated, the pumping member 28 traces out a path, which is preferably curved, and more preferably circular. The pumping member 28 preferably includes at least one arm 26 on which is attached one or more pump portions. Preferably, the pumping member 28 is configured such that the pump portions can rotate along a path to alternatingly and compressingly engage the first and second compressible portions 32,33 to pump the first and second fluids 40,41 therethrough. In one preferred embodiment, as shown in FIGS. 4 and 5, the pumping member 28 includes two arms 26,27 on which are attached two pump portions 24,25. In this embodiment, the pump portions 24,25 are rollers that are rotatable as they compress the compressible portions 32,33. Alternatively, the pumping member 28 includes two arms 26,27 that are configured to slide over and compress the compressible portions 32,33 to pump fluids therethrough. Preferably, the arms 26,27 are disposed about 180° from each other such that the compressible portions 32,33 can be engaged by the pump portions 24,25 concurrently as the pumping member 28 rotates about the fixing member 29. Alternatively, the arms 26,27 can be disposed at other angles from each other to vary the time between compressions of the compressible portions as desired.

The preferred embodiment also includes a pump motor 10 that is configured for rotating the pumping member 28. Preferably, the rate of rotation of the pump motor 10 can be adjusted by a motor controller such that when pumping member 28 is set to a high rate of rotation, more fluid 40,41 can be pumped through the conduits 44,45. In one embodiment, the motor controller can adjust the pump motor 10 to preferably stop the pumping member 28 in a loading position as shown in FIG. 4. Advantageously, stopping the pumping member 28 in the loading position maintains a sufficient clearance in the pumping spaces 21,31 to allow loading and extraction of the fluid conduits 44,45, preferably in a generally unimpeded manner, in and out from the pumping assembly 20 for easy loading and unloading of the sourcing assembly 50 thereon.

One preferred embodiment also includes first and second compression members 22,23 that are disposed in the walls of the pump housing 19, preferably substantially on opposite sides of the pumping member 28, and adjustably extend laterally to define the first and second pumping spaces 21,31. Preferably, the pumping member 28 is movable relative to the compression members 22,23 in at least one rotational position for insertion of the fluid conduits 44,45 in to the respective pumping spaces 21,31. The compression members 22,23 and the pump portions 24,25 are preferably adjustable relative to each other to change the size of the first and second pumping spaces 21,31. Preferably, the compression members 22,23 are threaded such that they are movable in the direction generally transverse to the axes of the compressible portions 32,33 and to the flow of fluids by. This can be achieved with threaded compression members 22,23, as shown in FIGS. 4 and 5, that can be screwed into and out of the pump housing 19. Additionally, the compression members 22,23 are preferably independently and automatically adjustable in the lateral direction by compression member motors 60,61. Alternatively, the compression members 22,23 are independently and automatically adjustable by a single compression member motor. In another embodiment, the compression members 22,23 can be adjusted manually.

Referring to FIG. 5, the first and second compressible portions 32,33 can be placed in the first and second pumping spaces 21,31 in pumpable association with the pumping member 28. When the pumping member 28 rotates, the pump portions 24,25 can preferably alternatingly compress and decompress the first and second compressible portions 32,33 against the respective compression members 22,23 to pump the first and second fluids 40,41 from the container members 42,43. By using the pump portions 24,25 to compress the compressible portions 32,33 against the compression members 22,23, the dispenser can advantageously dispense an accurate and consistent amount of fluid 40,41 each time the compressible portions 32,33 are compressed. The dispenser can be set up to dispense a variety of fluids, including, for example, food products with higher viscosities or suspended solids. Specifically, the dispenser is advantageously able to dispense fluids having a viscosities of about 1 to about 3500 cp. More preferably, the dispenser can dispense fluids with viscosities of about 100 to about 2000 cp.

Moreover, the amount of first fluid 40 that is dispensed from the first conduit 44, for example, can be varied independent of the amount of second fluid 41 that is dispensed from the second conduit 45 by separately moving each compression member 22,23 in or out of its respective pumping space 21,31. For example, the more that the first compression member 22 is moved into the first pumping space 21, the more that the first compressible portion 32 will be compressed by the pump portions 22,23 and thus the more that first fluid 40 will be dispensed from the first conduit 44. Importantly, the compression members 22,23 can be moved independent of each other which allows the user to separately control the amount of fluid 40,41 that is dispensed from each conduit 44,45 for preparing beverages that require different proportions of each fluid. The amounts of each fluid that are dispensed can also be adjusted to provide beverages contained in containers of different volumetric size.

In the preferred embodiment, the motor controller that controls the pump motor 10 also controls the compression member motors 60,61. Preferably, the motor controller receives input from the user as to the type and size of beverage desired, and controls or adjusts the pump motor 10 and/or the compression member motors 60,61 accordingly to vary the amounts of first and second fluids 40,41 that are dispensed.

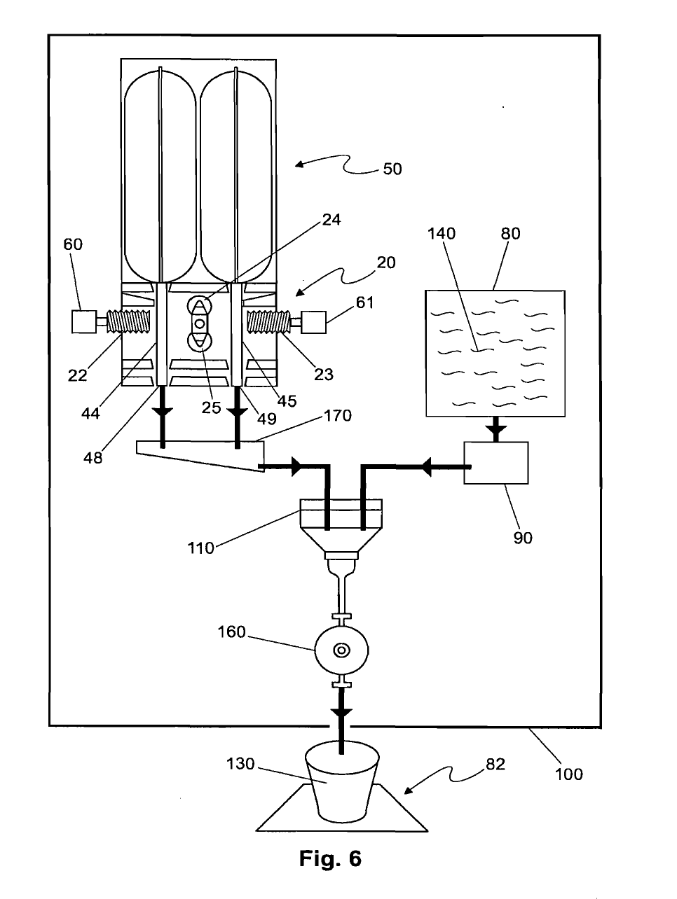

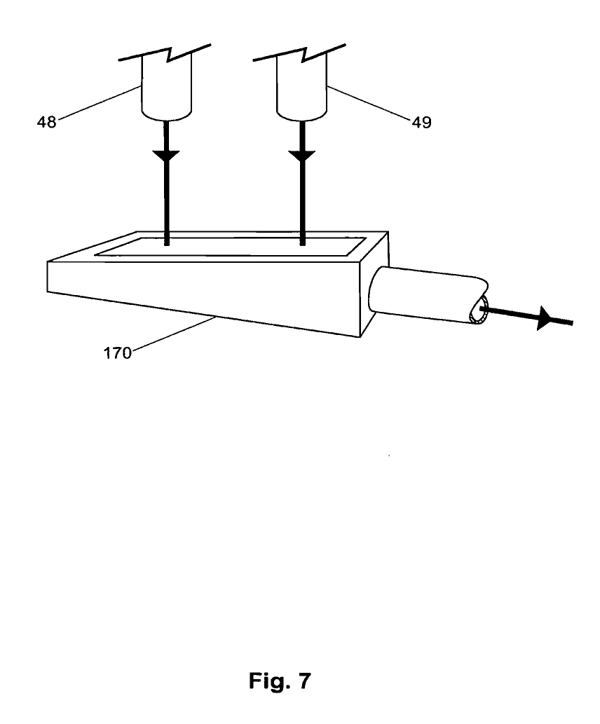

FIG. 6 shows one embodiment of the invention that includes a beverage dispenser having a dispenser housing 100 that preferably contains a fluid mixing collector 170 that collects the beverage components as they exit the pumping assembly 20. The beverage dispenser also includes a multiple fluid-sourcing assembly 50 that is associated with a pumping assembly 20 as previously described. Preferably, the fluid mixing collector 170 is disposed below the nozzles 48,49 of the first and second conduits 44,45 to receive and mix the beverage components therein. The fluid mixing collector 170 preferably has an inclined bottom panel, as shown in FIG. 7, that allows the mixed beverage components to easily exit the collector. Preferably, the beverage dispenser also includes a mixer 110 that receives the mixed beverage components from the fluid mixing collector 170.

The beverage dispenser also preferably includes a liquid supply 80 that can be associated with a pump 90. Preferably the liquid supply supplies water or another liquid 140 to dilute or mix the beverage components. The liquid 140 from the liquid supply 80 is preferably dispensed into the mixer 110 for mixing with the beverage components to prepare a beverage. The beverage is then be dispensed from the mixer 110, preferably passing through a whipper 160, and then into a serving container 130 received at a serving location 82. In one embodiment, the mixer 110 includes a heating or refrigeration element to heat or cool the mix of beverage components and liquid supply before dispensing.

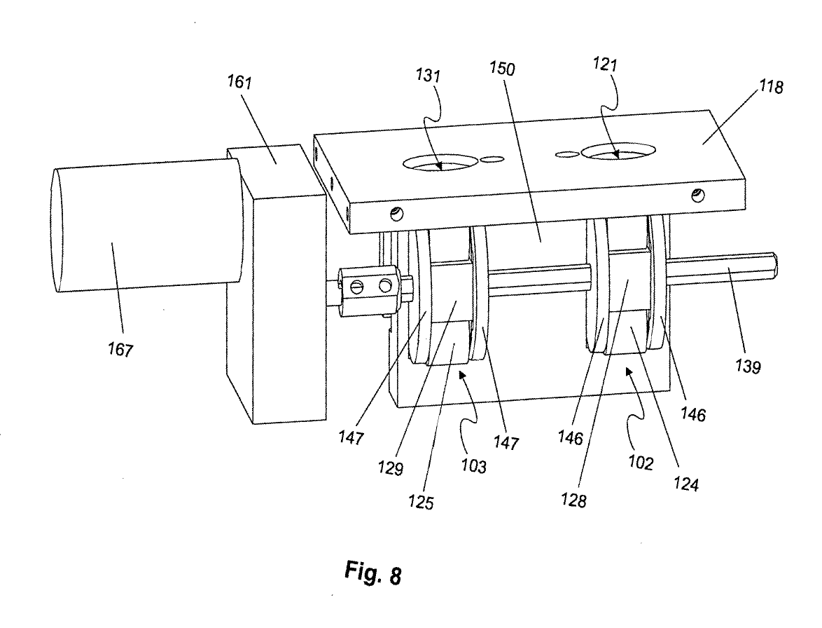

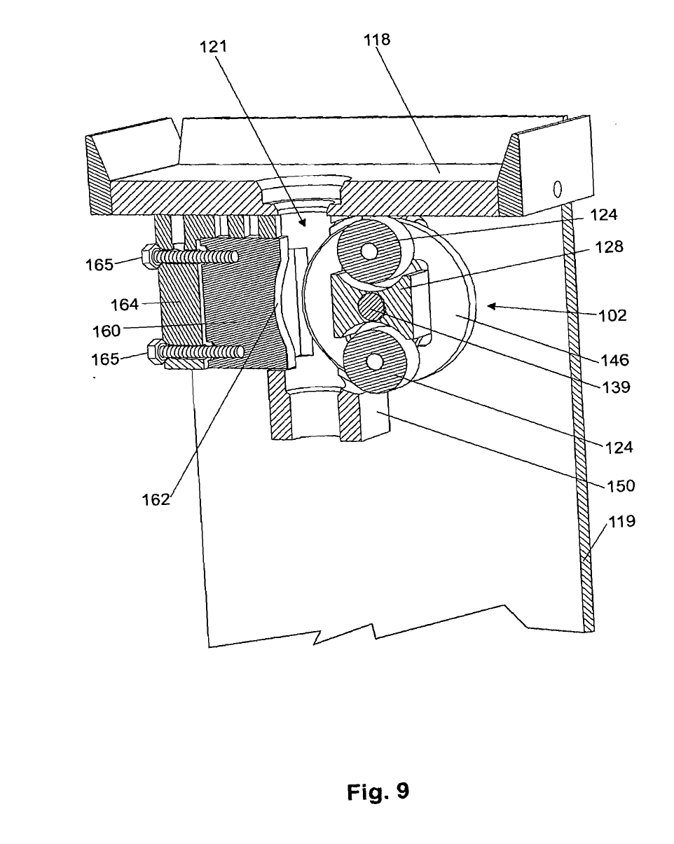

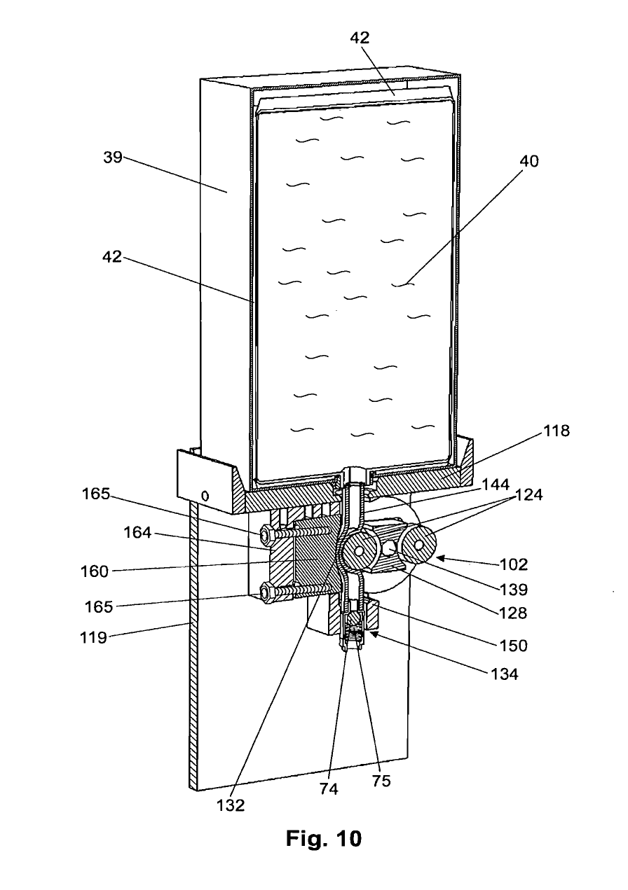

Another preferred embodiment of a pumping assembly of the present invention is shown in FIGS. 8-10. In this embodiment, the container housing 39, and the first and second container members 42,43 contained therein as previously described, is associated with conduit guide 118 of the pump housing 119. The conduit guide 118 is configured such that first and second conduits 144,145 can be easily inserted in first and second pumping spaces 121,131 to be in pumpable association, respectively, with first and second pumping members 128,129 of first and second peristaltic pumping mechanisms 102,103. In this embodiment, the conduit guide 118 preferably includes sidewalls that are raised with respect to the upper horizontal surface of the conduit guide 118 to further facilitate the stable and supportive association of the container housing 39 on the pump housing 119. Preferably, the first and second conduits 144,145 include, respectively, first and second compressible portions 132,133 for separate and independent engagement with the pumping members 128,129. For illustration purposes, FIGS. 9 and 10 only show the configurations of the first container member 42, first conduit 144, first compressible portion 132, first pumping space 121, first pumping member 128, and first peristaltic pumping mechanism 102, and their relationship to each other. The second container member 43, second conduit 145, second compressible portion 133, second pumping space 131, second pumping member 129, and second peristaltic pumping mechanism 103 share analogous construction and configuration, respectively. In another preferred embodiment, the container housing includes only a single container member containing a fluid therein and having an associated fluid conduit, and the pump housing contains only a single peristaltic pumping mechanism configured to pump the fluid through the fluid conduit.

The first conduit 144 also preferably includes a first downstream valve 134 that is disposed downstream of the compressible portion 132. The valve 134 is a uni-directional valve that is configured to allow only uni-directional flow of the first fluid 40 substantially only in a downstream direction out of the first container member 42 and through the first conduit 144. Preferably, the valve 134 is also configured to seal sufficiently against leakage of the first fluid 40 from the first conduit 144 during pumping of the first fluid 40 through the first conduit 144 as well as during non-pumping operations, for example, when the first conduit 144 is being loaded and unloaded from the first pumping space 121. More preferably, the first valve 134 is a check valve, such as spring-loaded, ball, check valves, as previously described.

In one preferred embodiment, the first and second peristaltic pumping mechanisms 102,103 include, respectively, first and second pumping member 128,129 disposed between a pair of outer flanges 146,147 as shown in FIG. 8. Preferably, the pumping members 128,129 each include at least one pump portion 124,125 for engaging the compressible portions 132,133 of the conduits 144,145. As an illustrative example of a preferred embodiment, the first pumping member 128 includes two pump portions 124 that are rollers disposed about 180° from each other. Advantageously, configuring the first pumping member 128 in this manner allows pumping wherein the first pumping member 128 is not in continuous pumpable association with the first compressible portion 132. This allows the first pumping member 128 to be moved to a loading position such that the pump portions 124 are substantially clear of the first pumping space 121 to facilitate generally unimpeded reception of the first conduit 144 therein, as shown in FIG. 9. Other embodiments can include a plurality of pump portions that are disposed from each other at angles less than 180°.

The pumping members 128,129 and the pair of outer flanges 146,147 are also preferably rotatably mounted on a rotatable motor shaft 139 and are configured to rotate about the axis of the motor shaft 139 such that the pumping members 128,129 trace out a path as they rotate thereabout. Preferably, the path is curved and more preferably the path is circular. The motor shaft 139 is associated with a pump motor 167 and motor transmission 161, as shown in FIG. 8, that are configured to rotate the motor shaft 139. A preferred embodiment also includes a motor controller that controls the pump motor 167. Preferably, the motor controller receives input from the user as to the type and size of beverage desired, and controls or adjusts the pump motor 167 accordingly to vary the amounts of first and second fluids that are dispensed. In other embodiments, the first and second pumping members 128,129 of the first and second pumping mechanisms 102,103 are separately mounted on different motor shafts associated with different motors such that one or more motor controllers can independently control the rotation of each pumping member 128,129, and thus the amount of fluid that is dispensed. The motor controller also advantageously enables the pumping members 128,129 to be rotated to and stopped in, preferably simultaneously, the loading position along the circular path, as shown in FIG. 9.

The peristaltic pumping mechanisms 102,103 are disposed adjacent a tubing block 150 that includes the first and second pumping spaces 121,131. Also disposed adjacent the peristaltic pumping mechanisms 102,103 is a squeeze block 160 that preferably has first and second curved surfaces 162,163 configured for associating, respectively, with the pump portions 124,125 of the pumping members 128,129 as they rotate about the motor shaft 139. Preferably, the squeeze block 160 is a stator and is associated with a back support 164 by at least one adjustable fixing member 165. Preferably, the adjustable fixing member 165 is a screw that is configured to secure the squeeze block 160 in a fixed position with respect to the peristaltic pumping mechanisms 102,103. The adjustable fixing member 165 is also configured to enable the squeeze block 160 and the first and second curved surfaces 162,163 thereon to be positioned closer in or further from the respective first and second pumping spaces 121,131. Advantageously, the positioning of the curved surfaces 162,163 with respect to the pumping spaces 121,131 allows for adjustment of the amount of fluid that is dispensed as the first and second pumping members 128,129 of the first and second peristaltic pumping mechanisms 102,103 engage the respective compressible portions 132,133 of the first and second conduits 144,145. Alternatively, the squeeze block 160 can include first and second squeeze blocks that include, respectively, the first and second curved surfaces 162,163 thereon and the squeeze blocks can be positioned independently to separately vary the amount of fluid that is dispensed from each conduit 144,145.

In one preferred embodiment shown in FIG. 10, the first and second conduits 144,145 can be inserted in the pumping spaces 121,131 and the peristaltic pumping mechanisms 102,103 are configured such that as the respective pumping members 128,129 rotate about the motor shaft 139 along a circular path, the pump portions 124,125 engage and contact the compressible portions 132,133 of the respective conduits 144,145. Upon contact, the compressible portions 132,133 are pinched against the curved surfaces 162,163 of the squeeze block 160. Preferably, the compressible portions 132,133 are pinched against the curved surfaces 162,163 such that the interior lumen of the conduits 144,145 is substantially, and more preferably completely, closed off. As the pumping members 128,129 rotate in a downward direction along the curved surfaces 162,163 and traced out by the circular path, the pump portions 124,125 push an increment of the first and second fluids down through the conduits 144,145 to effectuate dispensing thereof.

Advantageously, pumping the first and second fluids through the conduits 144,145 using the peristaltic pumping mechanisms 102,103 allows accurate and discrete portions of the fluids to be dispensed. The size of each portion can be adjusted by varying the angles between the pump portions or by adding additional pump portions to the pumping members 128,129 to decrease the spacing between the pump portions. Also, the total amount of each fluid that is dispensed can be adjusted by varying the speed of rotation of the motor shaft 139 or the total number of revolutions of the pumping members 128,129 during one dispensing cycle. The configuration of the peristaltic pumping mechanisms 102,103 also advantageously enable fluids having a wide range of viscosities to be dispensed including, for example, food products with high viscosities or suspended solids.

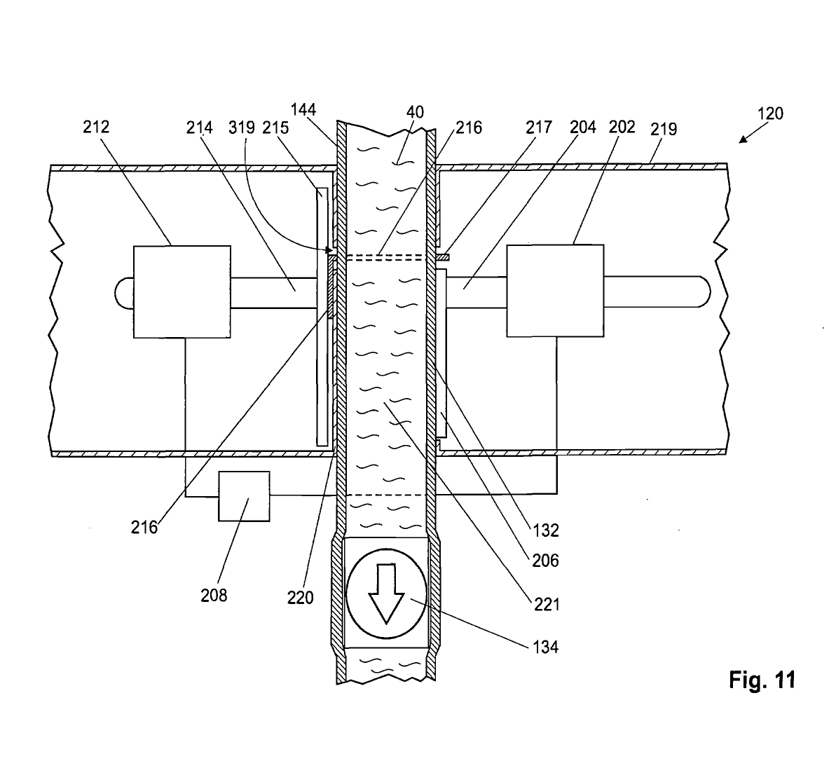

Still yet another preferred embodiment of a pumping assembly 120 of the present invention is shown in FIGS. 11-13. In this embodiment, the container housing and the first and second container members contained therein, as previously described, are associated with the pump housing 219. The pump housing 219 preferably includes a first pumping space 221 that is configured for receiving therein a first compressible portion 132 of a first conduit 144. The first conduit 144 preferably includes a first valve 134 that is disposed downstream of the first compressible portion 132. The first valve 134 is preferably a uni-directional valve, as previously described. Preferably, the pump housing also includes a second pumping space that is configured for receiving therein a second compressible portion of a second conduit.

A first pumping mechanism of the pumping assembly 120 preferably includes a first linear actuator that is associated with the first pumping member 206 and the first pinch member 216 to move the first pumping member 206 and first pinch member 216 between loading and pumping positions. In the preferred embodiment, the first linear actuator preferably includes a first pinch solenoid 212 and a first pump solenoid 202. In other embodiments, the first pumping mechanism includes pneumatic or hydraulic mechanisms, or non-linear actuators or motors, for moving the first pumping member and first pinch member in the loading and pumping positions.

The first pinch solenoid 212 is preferably associated with a first pinch member 216 that is configured for pinching the first compressible portion 132 to close off, preferably substantially, the lumen therein to prevent the backflow of the first fluid 40 during pumping. In one embodiment, the first pinch solenoid 212 is disposed opposite the first pump solenoid 202 with respect to the first compressible portion 132. The first pinch solenoid 212 is preferably associated with a first pinch member axle 214, at the end of which is disposed a first pinch disc 215. The first pinch member 216 preferably extends from the first pinch disc 215 such that a pinch portion 217 of the first pinch member 216 can be placed against one side of the first compressible portion 132. The first pinch solenoid 212 is preferably configured for moving the first pinch member axle 214 in the axial direction to position the first pinch member 216 in the loading and pumping position.

The first pump solenoid 202 is preferably associated with a first pump member axle 204, at the end of which is disposed the first pumping member 206. The first pumping member 206 preferably includes a substantially flat face that is configured for engaging, associating with, and compressing the side wall of the first compressible portion 132. The first pump solenoid 202 is preferably configured for moving the first pump member axle 204 in an axial direction to position the first pumping member 206 in the loading and pumping position.

In the loading position shown in FIG. 11, the first pumping member 206 and first pinch member 216 are preferably disposed to allow the first compressible portion 132 of the first conduit 144 to be received in and removed from the first pumping space 221. More preferably, the first pumping member 206 and first pinch member 216 are disposed substantially clear of the first pumping space 221 to facilitate generally unimpeded reception and removal of the first compressible portion 132 of the first conduit 144 therein and therefrom, respectively.

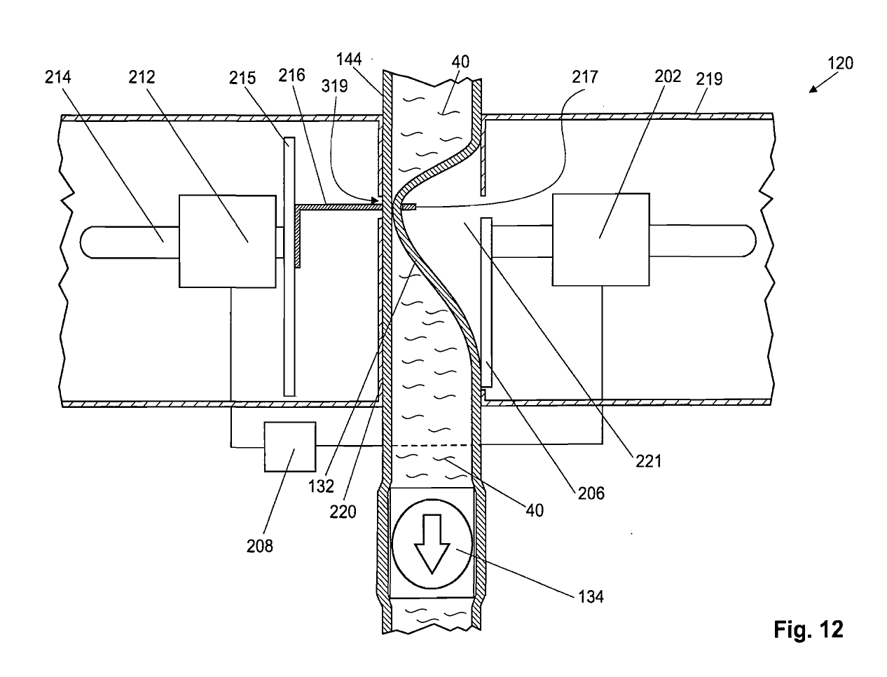

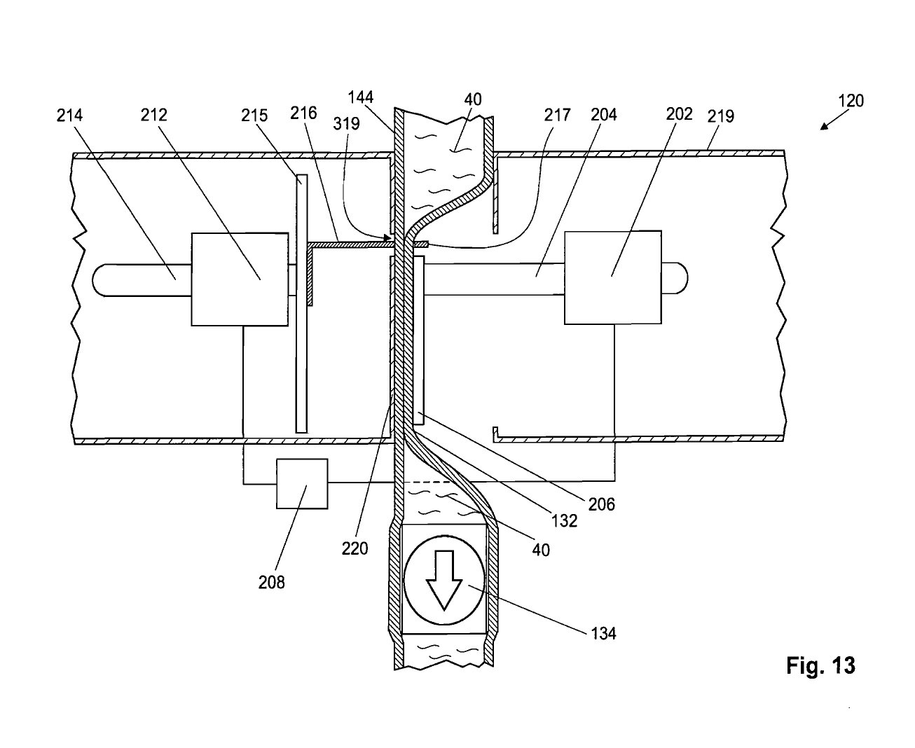

In the pumping position shown in FIGS. 12 and 13, the first pinch solenoid preferably moves the first pinch member 216 to block the backflow of the first fluid 40 into the first container member, as shown in FIG. 12. Preferably, the first pinch solenoid 212 moves the first pinch member axle 214 such that the first pinch member 216 is retracted through an opening 319 of the pump housing 219. Retraction of the first pinch member 216 causes the first pinch portion 217 to compress one side wall of the first compressible portion 132 against the other sidewall, thus closing the lumen thereof and preventing backflow of the first fluid therein.

The first pump solenoid 202 then preferably moves the first pump member axle 204 such that the first pumping member 206 engages and compresses against one side wall of the first compressible portion 132 in the first pumping space 221. Preferably, the first pumping member 206 compresses both side walls of the first compressible portion 132 against the wall 220 of the pumping housing 219, as shown in FIG. 13, to pump the first fluid 40 through the first conduit 144. The amount that the first compressible portion 132 is compressed by the first pumping member 206 can also be varied, depending on the amount of first fluid 40 that is to be pumped. After pumping, the first pinch and pump solenoids 212,202 preferably return, respectively, the first pinch member 216 and the first pumping member 206 to the loading position to allow the first fluid 40 to flow into the first compressible portion 132 from the first container.

The pumping assembly 120 also preferably includes a controller 208 that controls the first and second pumping mechanisms. Preferably, the controller 208 receives input from the user as to the type and size of beverage desired, and controls or adjusts the pumping mechanisms accordingly to vary the amounts of first and second fluids that are dispensed. For example, the controller 208 can vary the degree to which the first pumping member 206 compresses against the first compressible portion 132 in the first pumping space 221, thus varying the amount of first fluid 40 that is pumped through the first conduit 144. Additionally, the controller 208 can vary the amount of iterations that the first pumping member 206 compresses against the first compressible portion 132. The controller 208 also advantageously enables the pinch and pumping members of the first and second pumping mechanisms to be moved to and stopped in, preferably simultaneously, the loading position.

The pumping assembly 120 can also preferably include a second pumping mechanism and associated second members that are similarly configured to the first pumping mechanism and first members previously described for pumping a second fluid from the second container member.

The term “about,” as used herein, should generally be understood to refer to both numbers in a range of numerals. Moreover, all numerical ranges herein should be understood to include each whole integer within the range.

While illustrative embodiments of the invention are disclosed herein, it will be appreciated that numerous modifications and other embodiments can be devised by those skilled in the art. Features of the embodiments described herein, can be combined, separated, interchanged, and/or rearranged to generate other embodiments. Therefore, it will be understood that the appended claims are intended to cover all such modifications and embodiments that come within the spirit and scope of the present invention.

What is claimed is:

1. A dispensing system, comprising:
first and second container members containing first and second fluids, respectively;
first and second conduits respectively in fluid communication with the first and second container members to allow the fluids to pass therethrough;
a first pumping space defined for receiving the first conduit therein;
a second pumping space defined for receiving the second conduit therein; and
a pumping mechanism comprising a pumping member;
wherein the pumping member has a loading position in which the pumping member is disposed to allow the first and second conduits to be received in and removed from the first and second pumping spaces, respectively; and
wherein the pumping member has a pumping position in which the pumping member engages the first conduit in the first pumping space and the second conduit in the second pumping space to establish fluid association to pump the first and second fluids through the first and second conduits, respectively.

2. The dispensing system of claim 1 further comprising at least one valve disposed in the first conduit configured to seal against leakage of the first fluid from the first conduit, wherein the valve is configured to allow the first fluid to flow substantially only outwardly and downstream of the first container member.

3. The dispensing system of claim 2, wherein:
the first conduit comprises a first compressible portion;
the valve is disposed downstream of the first compressible portion; and
the pumping member in the pumping position is engaged with the first compressible portion of the first conduit to compress the first compressible portion and pump the first fluid therethrough.

4. The dispensing system of claim 1, wherein the pumping member is configured to move along a path through the loading and pumping positions, and the pumping position comprises a range of positions along the path wherein the pumping member engages the first and second conduits.

5. The dispensing system of claim 4, wherein the pumping member is configured to simultaneously move along and against the first and second conduits to simultaneously pump the first and second fluids through the first and second conduits, respectively, when the pumping member is in the pumping position.

6. The dispensing system of claim 4, wherein the pumping member is configured to substantially pinch the first and second conduits during the movement along the path in the pumping position.

7. The dispensing system of claim 4, wherein the pumping mechanism is rotatable to rotate the pumping member through the loading and pumping positions.

8. The dispensing system of claim 1, wherein the pumping mechanism comprises a linear actuator that is operably associated with the first pumping member and configured to move the first pumping member between the loading and pumping positions.

9. The dispensing system of claim 1, wherein the pumping mechanism comprises a peristaltic pump, and the pumping member is configured to substantially pinch the first and second conduits against a surface of a first backing member and a second backing member, respectively, and push the first and second fluids through the first and second conduits, respectively.

10. The dispensing system of claim 1, wherein when the pumping member is in the loading position, the pumping member is disposed to maintain a sufficient clearance with the first and second conduits to allow the first and second conduits generally unimpeded reception into and removal from the first and second pumping spaces.

11. The dispensing system of claim 1, further comprising a controller configured for stopping the pumping member in the loading position.

12. The dispensing system of claim 1, wherein the dispensing system further comprises:
a second compressible portion defined in the second conduit; and
at least one valve disposed in the second conduit downstream of the second compressible portion configured to seal against leakage of the second fluid from the second conduit;
wherein the pumping member has a pumping position in which the pumping member engages the second compressible portion of the second conduit to establish fluid association to pump the second fluid therethrough.

13. The dispensing system of claim 12, wherein the first and second container members are disposed at a predetermined spacing from each other to allow simultaneous loading of the first and second conduits in the first and second pumping spaces when the pumping member is in the loading position.

14. The dispensing system of claim 13, further comprising a conduit guide configured for guiding the first and second conduits for loading in the first and second pumping spaces,
wherein the conduit guide defines an upstream opening configured to facilitate reception therein of the first and second conduits which is larger than at least a portion of the conduit guide disposed downstream of the upstream opening.

15. The dispensing system of claim 1, wherein the peristaltic pump comprises:
a motor in drivable association with the pumping member to move the pumping member along the path;
a first backing member that is adjustably positioned with respect to the pumping member, the first backing member having a surface configured to cooperate with the pumping member to pinch the first conduit therebetween when the pumping member engages that conduit to establish peristaltic association in the pumping position to peristaltically pump a fluid therethrough; and
a second backing member that is adjustably positioned with respect to the pumping member, the second backing member having a surface configured to cooperate with the pumping member to pinch the second conduit therebetween when the pumping member engages that conduit to establish peristaltic association in the pumping position to peristaltically pump a fluid therethrough;
wherein when the pumping member is in the loading position, the pumping member is disposed to allow each conduit to be received in and removed from a pumping space.

16. The dispensing system of claim 15, wherein the pump is configured to fully release the conduits by moving the pumping member to the loading position.

17. The dispensing system of claim 15, wherein the motor is associated with the pumping member to rotate the pumping member along the path through the pumping and loading positions.

18. The dispensing system of claim 15, further comprising a controller configured for controlling the motor to stop the pumping member in the loading position.
